(19) United States
(12) Patent Application Publication
(10) Pub. No.: US 2009/0296290 A1
(43) Pub. Date: Dec. 3, 2009

(54) LENZ ROUTE

(76) Inventors: Yen-Wei Hsu, (US); Whei-Chyou Wu, Fremont, CA (US)

Correspondence Address: Yen-Wei Hsu, 7F No. 58, Jhouzih St.,Neihu District,, Taipei, 11459, TW

(21) Appl. No.: 12/127,832

(22) Filed: May 28, 2008

(51) Int. Cl. H02H 9/00

(52) U.S. Cl. 361/54

(57) ABSTRACT

The present invention relates to Lenz effect in a circuit. When a close loop is suddenly opened or closed, the Lenz voltage will be generated at inductor in the loop. The Lenz current generated by the Lenz voltage flows oppositely to the normal current and it usually comes with very high and broadband frequency. The design of a Lenz route parallel to an inductor in a circuit can dissipate the Lenz power to stabilize the circuit. The design of a Lenz route can also be applied to a switch to protect the switch against the Lenz effect.

### TECHNICAL FIELD OF THE INVENTION

A first objective of the present invention is to provide a Lenz route parallel to an inductor in a circuit to dissipate the Lenz power so that the circuit will present more stability and less noises. A second objective of the present invention is to provide a Lenz route to a switch to protect the switch against the Lenz effect.

### BACKGROUND OF INVENTION

More electronic devices have been invented and they have been used in many different fields and applications. A lot of critical problems still exist in the devices and can't be solved for quite long time. Those problems include accumulated heat, noise and low sensitivity which will cause the devices and systems unstable. The present invention can benefit the devices and systems with some advantages:
(1) Thermo issues are massively reduced.
(2) The noise problems are significantly neutralized.
(3) The new devices and systems are more sensitive and reliable.
(4) The new devices and systems can get highly dynamic response and broadening bandwidth.
(5) The new devices and systems are potentially scalable.

The background of the invention is introduced by beginning from mathematical model and through some representative devices and circuits. First, the Cauchy-Riemann equations are used to describe a system's impedance behaviors. Consider the impedance z in the complex form of

z=F(i,v)+jG(i.v) (1)

where i, v are current and voltage respectively. Assumed that the functions F (i, v) and G(i.v) are analytic in the specific domain, from the Cauchy-Riemann equations as following

$$\begin{matrix}\frac{\partial F}{\partial i} = \frac{\partial G}{\partial v} and & ( 2 ) \\ \frac{\partial F}{\partial v} = \frac{\partial G}{\partial i} & ( 3 )\end{matrix}$$

Using the chain rule, we further obtain from the equations (2) and (3)

$$\begin{matrix}\frac{\partial F}{\partial ω} \frac{\partial ω}{\partial i} = \frac{\partial G}{\partial ω} \frac{\partial ω}{\partial v} and & ( 4 ) \\ \frac{\partial F}{\partial ω} \frac{\partial ω}{\partial v} = - \frac{\partial G}{\partial ω} \frac{\partial ω}{\partial i} & ( 5 )\end{matrix}$$

where the variable ω may be the frequency, temperature, magnetic flux density, optical intensity and so on. Let the terms

$$\begin{matrix}\{ \begin{matrix}\frac{\partial ω}{\partial i} > 0 \\ \frac{\partial ω}{\partial v} > 0\end{matrix} \\ or & ( 6 ) \\ \{ \begin{matrix}\frac{\partial ω}{\partial i} < 0 \\ \frac{\partial ω}{\partial v} < 0\end{matrix} & ( 7 )\end{matrix}$$

be non-zero and the same sign. Under the same sign conditions as the equation (6) or (7), from the equations (4) and (5),

$$\begin{matrix}\frac{\partial F}{\partial ω} > 0 \\ and & ( 8 ) \\ \frac{\partial F}{\partial ω} < 0 & ( 9 )\end{matrix}$$

should be held simultaneously. Equation (8) expresses the slope of impedance function a positive value which is called Positive Differential Resistivity or simply in short as PDR. Equation (9) expresses the slope of impedance function a negative value which is called Negative Differential Resistivity or simply in short as NDR. From the point of view of making a power source, the simple way to perform equation (6) and (7) is using the pulse-width modulation (PWM) method. The further meaning of equation (6) and (7) is that using the variable frequency ω in pulse-width modulation to current and voltage is the most straightforward way, i.e.,

$$\{ \begin{matrix}\frac{\partial ω}{\partial i} \neq 0 \\ \frac{\partial ω}{\partial v} \neq 0\end{matrix}$$

In nature,

$$\frac{\partial F}{\partial ω} and \frac{\partial G}{\partial ω}$$

are positive or in general, under the condition like as the (9.1)

$$\frac{\partial F}{\partial ω} \frac{\partial G}{\partial ω} > 0 \qquad ( 9.1 )$$

Putting equation (9.1) into (4) and (5), we obtain

$$\frac{\partial ω}{\partial i} \frac{\partial ω}{\partial v} < 0 \qquad ( 9.2 )$$

Surprisingly, we can find a negative slope in the I-V curve of some special fiber-carbon materials

$$\frac{d V}{d I} = - R$$

or in parameter form

$$\frac{\frac{d V}{d ω}}{\frac{d I}{d ω}} = - R$$

where the resistance R is a positive value,

$$R > 0 or \frac{d V}{d ω} \frac{d I}{d ω} < 0$$

also its equivalent form

$$\frac{d ω}{d V} \frac{d ω}{d I} < 0$$

The negative sign contributed from the current or voltage has a backward direction with respect to input current I or voltage V. In particular, this reverse current (−I) is to be called “back flow current.” Considering a semiconductor case is setting the voltage to be a multi-frequency pattern as

$$v ( t ) = {\sum }_{i = 0}^{∞} {v}_{i} ( {ω}_{0} , {ω}_{1} , … ) {e}^{j ( {ω}_{i} t + {φ}_{i} )} \qquad ( 9.3 )$$

which is produced by the PWM controller in the power source and its corresponding current is

$$i ( t ) = {I}_{0} ( {e}^{( \frac{q {\sum }_{i = 0}^{∞} {v}_{i} ( {ω}_{0} , {ω}_{1} , … ) {e}^{j ( {ω}_{i} t + {φ}_{i} )}}{kT} )} - 1 ) \qquad ( 9.4 )$$

where q (Coulomb) is the elementary charge,

q=1.602×10⁻¹⁹ (C)

$$k ( \frac{Joule}{K°} )$$

is the Boltzmann constant,

k=1.380×10⁻²³

T (K°) is the absolute temperature of the P-N junction.

After obtaining the qualitative behaviors of PDR and NDR expressed by the equations (8) and (9) above, now we further look their quantitative behaviors. In theory, for a closed loop whose impedance is in the form of the equation (1) can be analogical to a simple parallel oscillator shown in FIG. 9 or a simple series oscillator shown in FIG. 10 of which both correspond to a 2^{nd}-order differential equation shown respectively by the equation (12) or (15). Please refer to some references [13, Vol 2, Chapter 8,9,10,11,22,23], [7, Page 173], [2, Page 181], [8, Chapter 10] and [6 Page 951-968]. First, a simple parallel oscillator has been shown in FIG. 9. Let the current iₗ and voltage v_{C} be replaced by x, y respectively. From the Kirchhoff's Law, this simple oscillator is expressed as the form of

$$\begin{matrix}L \frac{d x}{d t} = y & ( 10 ) \\ C \frac{d y}{d t} = - x + {F}_{p} ( y ) & ( 11 )\end{matrix}$$

or in matrix form

$$[ \begin{matrix}\frac{d x}{d t} \\ \frac{d y}{d t}\end{matrix} ] = [ \begin{matrix}0 & \frac{1}{L} \\ - \frac{1}{C} & 0\end{matrix} ] [ \begin{matrix}x \\ y\end{matrix} ] + [ \begin{matrix}0 \\ \frac{{F}_{p} ( y )}{C}\end{matrix} ] \qquad ( 12 )$$

where the function Fₚ(y) represents the generalized Ohm's law and for the single variable case, Fₚ(y) is the real part function of the impedance function shown by the equation (1). “p” here stands for “parallel” oscillator. Furthermore, the equation (12) is a Liénard system which will be explained later. If taking the linear from of Fₚ(y),

Fₚ(y)=Ky

and K>0, it is a normally linear Ohm's law. Also, the state-equation of a simple series oscillator shown in FIG. 10 is

$$\begin{matrix}L \frac{d x}{d t} = y - {F}_{s} ( x ) & ( 13 ) \\ C \frac{d y}{d t} = - x & ( 14 )\end{matrix}$$

Or in the matrix form,

$$[ \begin{matrix}\frac{d x}{d t} \\ \frac{d y}{d t}\end{matrix} ] = [ \begin{matrix}0 & \frac{1}{L} \\ - \frac{1}{C} & 0\end{matrix} ] [ \begin{matrix}x \\ y\end{matrix} ] + [ - \frac{{F}_{s} ( x )}{\begin{matrix}L \\ 0\end{matrix}} ] \qquad ( 15 )$$

Where i_{C}, vₗ are replaced by x, y respectively. The function Fₛ(x) indicates the generalized Ohm's law, and, for the single variable case, Fₛ(x) is the real part of the impedance function shown by the equation (15). Here “s” stands for “series” oscillator. Further, the equation (15) is the Liénard system too. Again, considering one system as shown by the equation (15), let L, C be to one, then the system becomes the form of

$$[ \begin{matrix}\frac{d x}{d t} \\ \frac{d y}{d t}\end{matrix} ] = [ \begin{matrix}y \\ - x + {F}_{p} ( y )\end{matrix} ] \qquad ( 16 )$$

To obtain the equilibrium point of the systems by the equations (15) and (16), setting the right hand side of the equations (15) and (16) to zero

$$\begin{matrix}\{ \begin{matrix}0 = y \\ 0 = - x + {F}_{p} ( y )\end{matrix} \\ \{ \begin{matrix}0 = y - {F}_{s} ( x ) \\ 0 = - x\end{matrix}\end{matrix}$$

where Fₚ(0) and Fₛ(0) are the values of the generalized Ohm's law at zero. The gradient of equation (16) is

$$[ \begin{matrix}{F}_{s}^{′} ( 0 ) & 1 \\ - 1 & 0\end{matrix} ]$$

Let the slope of the generalized Ohm's law F′ₛ(0) be a new function as fₛ(0)

fₛ(0)≡F′ₛ(0)

the correspondent eigenvalues λ^{s}_{1,2} are as

$${λ}_{1 , 2}^{s} = \frac{1}{2} [ - {f}_{s} ( 0 ) \pm \sqrt{{( {f}_{s} ( 0 ) )}^{2} - 4} ]$$

Similarly, in the simple parallel oscillator shown by the equation (12),

fₚ(0)≡F′ₚ(0)

the equilibrium point of the equation (12) is set to (Fₚ(0),0) and the gradient of the equation (12) is

$$[ \begin{matrix}0 & 1 \\ - 1 & {f}_{p} ( 0 )\end{matrix} ]$$

the correspondent eigenvalues λ^{p}_{1,2} are

$${λ}_{1 , 2}^{p} = \frac{1}{2} [ - {f}_{p} ( 0 ) \pm \sqrt{{( {f}_{p} ( 0 ) )}^{2} - 4} ]$$

The qualitative properties of the systems shown by the equations (12) and (15), referred to [6] and [8], are as the following:
1. fₛ(0)>0, or fₚ(0)<0, its correspondent equilibrium point is a sink.
2. fₛ(0)<0, or fₚ(0)>0, its correspondent equilibrium point is a source.
   Thus, observing the above definitions of sink and source, a positive value of the slope value of impedance function Fₛ(x) or fₛ(x), or, a positive value of the slope of impedance function Fₚ(y), or fₚ(y) are called “positive differential resistivity” or simply “PDR”. They are shown by the equations (17) and (18) respectively below. If the value of derivative of the impedance function of any device or assembly is larger than zero, we can call the device or assembly presenting PDR property in the present invention.

F′ₛ(x)=fₛ(x)>0 (17)

or

F′ₚ(y)=fₚ(y)>0 (18)

On the contrary, a negative value of the slope value of impedance function Fₛ(x) or fₛ(x), or, a negative value of the slope of impedance function Fₚ(y), or fₚ(y) are called “negative differential resistivity” or simply “NDR”. They are shown by the equations (19) and (20) respectively below. If the value of derivative of the impedance function of any device or assembly is smaller than zero, we can call the device or assembly presenting NDR property in the present invention.

F′ₛ(x)=fₛ(x)<0 (19)

or

F′ₚ(y)=fₚ(y)<0 (20)
3. if fₛ(x)=0, or fₚ(y)=0 shown by the equations (21) and (22), its correspondent equilibrium point is a bifurcation point. Please referred to [9, Page 433], [10, Page 26] and [8, Chapter 10].

F′ₛ(x)=fₛ(x)=0 (21)

or

F′ₚ(y)=fₚ(y)=0 (22)

Semiconductor devices are widely used in many applications and the behaviors of their impedance function are worth noticing. Now a superconductor Josephson junction device has been introduced in some books as [4, Chapter 2, 3, 4, 5], [13, Vol. 3, Section 14.4], [12, section 4.6] and also referred by the invention describing Josephson junction device. Josephson junction device is discussed here because it has been well modeled and analyzed, and, the device is a representative of semiconductor P-N junction which is widely seen in many semiconductor devices. The behavior of semiconductor P-N junction is very dynamical and is hard to predict. This weak coupling exists in the junction causes the devices a lot of problems such as thermo heat, noise and low sensitivity, etc. Those problems are seen in almost all the semiconductor devices such as in solar cells, Hall sensors, ICs, IGBTs, Thyristors, CPUs, DSPs, ASICS, IPMS, MOSFETs, SCRs, CCD, LEDs, transistors, laser diodes and diodes, dielectric resonator antenna (DRA), digital controllers or micro controllers, transmission lines and waveguides, fiber communication devices, data buses, sodium lamps, mercurial bulbs, etc. and they will eventually cause the devices and systems unstable or overheated.

A superconducting Josephson junction device is an equivalent circuit can be modeled as a simple parallel oscillator expressed by the equation (12). More detailed of Josephson junction device can be referred by some books [4, Chapter 2,3,4,5], [12, Section 4.6].

Now we are going to find out what kind of conditions are needed for a system to be stabilized. Liénard theorem is helpful to explain this. Taking the system as expressed by the equation (12) or (15) is treated as a nonlinear dynamical system, we can extend these systems to be a well-known result on the existence of the limit cycle, referred to [11, Page 253-260], [10, Page 402-407], for a dynamical system as the form of

$$\{ \begin{matrix}\frac{d x}{d t} = y - F ( x ) \\ \frac{d y}{d t} = - g ( x )\end{matrix} \qquad ( 23 )$$

under certain conditions on the functions F and g. Or its equivalent form of a nonlinear dynamics from the equation (23) as

$$\frac{{d}^{2} x}{d {t}^{2}} + f ( x ) \frac{d x}{d t} + g ( x ) = 0 \qquad ( 24 )$$

where the damping function f(x) is the first derivative of impedance function F(x) with respect to the state x

f(x)=F′(x) (25)

Based on the spectral decomposition theorem [2, Chapter 7], the damping function has to be a non-zero value if it is a stable system. The impedance function is

y=F(x) (26)

From the equations (23), (24) and (25), the impedance function F(x) is the integral of damping function f(x) over one specific operated domain x>0 as

F(x)=∫₀^{x}f(x)dx (27)

Under the assumptions that F, gεC¹(R), F and g are odd functions of x, F(0)=0, F′(0)<0, F has single positive zero at x=a, and F increases monotonically to infinity for x≧a as x→∞, it follows that the Liénard system by equation (23) has exactly one limit cycle and it is stable. Comparing the equation (27) to the bifurcation point defined by the equation (21) or (22), the initial condition of the equation (27) is extended to an arbitrary setting as

F(x)=∫ₐ^{x}f(x)dx (28)

where aεR. We conclude that an adaptive-dynamic impedance function F(x) has the following properties:
1. The damping function is not a constant. At the interval,

α≦a

the impedance function F(x) is

F(x)<0

The derivative of function F(x)

F′(x)=f(x)>0 (29)

This is a positive differential resistivity or simply PDR as defined by the equation (17) or (18), or,

F′(x)=f(x)<0 (30)

this is a negative differential resistivity or simply NDR as defined by the equation (19) or (20) of which both are held simultaneously. It means that the impedance function F(x) has the negative and positive slopes at the interval α≦a.
2. Following the Liénard theorem [11, Page 253-260], [8, Chapter 10,11], [10, Chapter 8] and the correspondent theorems, corollaries and lemma, we can further conclude that one stabilized system which has at least one limit cycle, all solutions to the system by equation (23) converge to this limit cycle even asymptotically stable periodic closed orbit. In fact, this kind of system construction can be realized a stabilized system in Poincaré sense [11, Page 253-260], [8, Chapter 10,11], [7, Chapter 1,2,3,4], [2, Chapter 3].

### SUMMARY OF THE INVENTION

A first objective of the present invention is to provide a Lenz route parallel to an inductor in a circuit to dissipate the Lenz power so that the circuit will present more stability and less noises.

A second objective of the present invention is to provide a Lenz route to a switch to protect the switch against the Lenz effect.

### BRIEF DESCRIPTION OF THE DRAWINGS

FIG. 1 has shown a circuit with a DC power source comprising two inductors, a switch and two Lenz routes;

FIG. 2 has shown a capacitor as a signal-coupling device coupled with the first Lenz route;

FIG. 3 has shown a general Hall device as a signal-coupling device coupled with the first Lenz route;

FIG. 4 has shown the first Lenz route further comprising a transformer coil of a transformer;

FIG. 5 has shown a circuit with AC power source comprising two inductors and two Lenz routes;

FIG. 6 has shown a simplified structure of the four-lamina carbon fiber composite;

FIG. 7 has shown the symbol of a four-port decoupler;

FIG. 8 has shown the first Lenz route comprising a decoupler;

FIG. 9 has shown a parallel oscillator circuit; and

FIG. 10 has shown a series oscillator circuit,

### DESCRIPTION OF THE PREFERRED EMBODIMENT

The properties of the PDR and NDR have respectively been defined by the equations (9.1) and (9.2). A device is called PDR-equipped device if the device has PDR property. A device is called NDR-equipped device if the device has NDR property. A device is called PNDR-equipped device if it has PDR and NDR properties.

An assembly includes at least two devices serially coupled with each other and all the devices of the assembly are PDR-equipped devices then the assembly is called PDR-equipped assembly. An assembly includes at least two devices serially coupled with each other and all the devices of the assembly are NDR-equipped devices then the assembly is called NDR-equipped assembly. An assembly includes at least two devices serially coupled with each other and the assembly comprises a PDR-equipped device and a NDR-equipped device then the assembly is a PNDR-equipped assembly.

A PDR-equipped assembly can become PNDR-equipped assembly by adding at least one NDR-equipped device serially coupled with any one device of the assembly and no more PDR-equipped device is needed although the assembly is still allowed to be added more PDR-equipped device. A NDR-equipped assembly can become PNDR-equipped assembly by adding at least one PDR-equipped device serially coupled with any one device of the assembly and no more NDR-equipped device is needed although the assembly is still allowed to be added more NDR-equipped device. A PNDR-equipped assembly needs no more added PDR-equipped and NDR-equipped devices although the assembly is still allowed to be added more PDR-equipped and NDR-equipped devices. A PNDR-equipped assembly can be achieved by including all the possible ways explained above in the present invention.

For example, if a loop originally includes five devices serially coupled with each other and if the loop comprises a PDR-equipped device and a NDR-equipped device of the five devices then the loop is for sure a PNDR-equipped loop. If all the five devices originally in the loop are PDR-equipped devices then at least a NDR-equipped device is needed to be added to serially couple with any one device of the loop to make the loop a PNDR-equipped loop. If all the five devices originally in the loop are NDR-equipped devices then at least a PDR-equipped device is needed to be added to serially couple with any one device of the loop to make the loop a PNDR-equipped loop. If the properties of the five devices are not known then a PDR-equipped device and a NDR-equipped device can still be serially coupled with any one device of the loop to make sure that the loop is a PNDR-equipped loop.

If an assembly is written by comprising at least a device, at least a PDR-equipped device and at least a NDR-equipped device serially coupled with each other. The device or devices other than the PDR-equipped and NDR-equipped devices can have PDR or NDR property or even both properties, and the device or devices can also be accounted as the PDR-equipped and NDR-equipped devices in the assembly.

For example, if a loop is expressed comprising a X, a Y, a Z, a PDR-equipped device and a NDR-equipped device serially coupled with each other. The devices, which are the X, Y and Z, other than the PDR-equipped device and NDR-equipped device in the assembly can also have PDR or NDR property or even both properties, and, the device or devices can be accounted the PDR-equipped and NDR-equipped devices in the loop. For example, if the X is a PDR-equipped device then the loop can also be expressed by comprising the X, Y, Z and a NDR-equipped device serially coupled with each other. If the Y is a NDR-equipped device then the loop can also be expressed by comprising the X, Y, Z and a PDR-equipped device serially coupled with each other. If the Y is a NDR-equipped device and the Z is a PDR-equipped device then the the loop can also be expressed by comprising the X, Y and Z serially coupled with each other. If the properties of the X, Y and Z are unknown then the loop still can be expressed by comprising the X, Y, Z, the PDR-equipped device and the NDR-equipped device serially coupled with each other. The X, Y and Z can be the PDR-equipped and NDR-equipped devices, or, the PDR-equipped and NDR-equipped devices can be the devices other than the X, Y and Z. A transmission line coupling the devices in the loop can be accounted for a device in the loop, for example, the X can be a transmission line.

If an assembly is expressed by comprising at least a device, at least a PDR-equipped device and at least a NDR-equipped device serially coupled with each other the assembly includes all the possibilities discussed above. The present invention is not limited to any particular way to make an assembly a PNDR-equipped assembly.

When a close loop is suddenly opened or closed, the Lenz voltage will be generated at inductance type load such as inductor in the loop. The Lenz current generated by the Lenz voltage flows oppositely to the normal current and it usually comes with very high and broadband frequency. The circuit will presents unstable and noises if the reversed generated Lenz current is blocked somewhere in the circuit, for example, an inductor becomes to present very high impedance when the high frequency Lenz current flows thru the inductor.

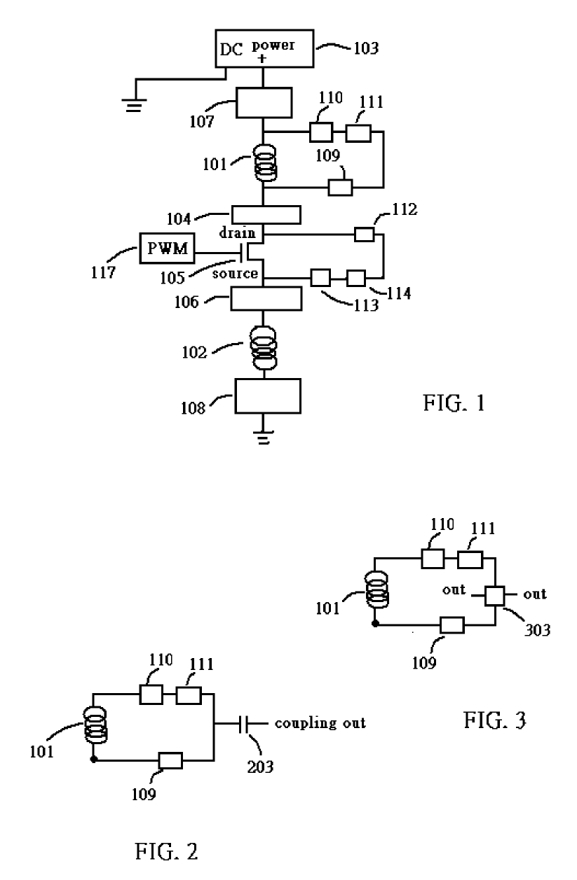

A circuit comprising a frequency-modulated DC power source and an inductor is discussed first. A frequency-modulated DC power source can be expressed by comprising a switch controlled by a PWM controller. A circuit in a general form shown in FIG. 1 includes a DC power source 103, a first inductor 101, a second inductor 102, a first block 107, a second block 104, a third block 106, a fourth block 108 and a switch which is demonstrated by a power module 105 serially coupled with each other. A PWM controller 117 provides control of turn-on and turn-off of the power module 105. The first and second inductors 101, 102 are respectively located at the drain and source sides of the power module 105 and the two inductors 101, 102 are respectively the closest inductors to each side of the power module 105. The blocks 104, 106, 107 and 108 respectively stand for any “possible” component and/or subsystem such as transmission line, resistor, etc.

The switch mentioned in the present invention includes at least two terminals, which can be respectively specified as a first terminal and a second terminal in the present invention, and the two terminals can become electrically connected or disconnected controlled by any method. The switch is demonstrated by the power module 105 which has three terminals in which the drain and source terminals can become electrically connected or disconnected controlled by an input of the gate terminal.

The loop shown in FIG. 1 is switching on and off at a frequency. When the loop is suddenly opened at the power module 105, the Lenz voltages are generated at the first inductor 101 and second inductor 102. The Lenz voltages are generated at the side of the first inductor 101 closer to the opened point and the side of the second inductor 102 closer to the opened point.

The Lenz currents generated by the Lenz voltages flow oppositely to the normal current from the power source 103. The reversed Lenz current will flow toward the first inductor 105 and the power module 105. The reversed Lenz current flowing toward the first inductor 105 is hard to go thru the first inductor 101 for its high impedance so that a first Lenz route parallel to the first inductor 101 is designed to let the reversed Lenz current flow thru it. The reversed Lenz current flowing toward the power module 105 could potentially strike the power module 105 so that the two ends of a second Lenz route respectively electrically couple the source and drain terminals of the power module 105 to let the reversed Lenz current flow thru it. A loop formed by a Lenz route and its parallel device can be called Lenz loop in the present invention.

It is expected that the normal current from the power source 103 will not flow thru the two Lenz routes, which means that the two Lenz routes are expected to be input-unrelated. The “Input” of “input-unrelated” means that the current is from the power source. A device making a Lenz route as an input-unrelated Lenz route is called input-unrelated device in the present invention. For example, for the loop with a DC power source shown in the embodiment of FIG. 1, the input-unrelated device can be a capacitor, variator or a diode, etc. The DC current from the power source cannot pass through the capacitor but the reversed high frequency AC Lenz current can flow thru the capacitor so that the capacitor can be an input-unrelated device. The diode is an unidirectional device which can only allow the current to flow in one direction so that the diode can be an input-unrelated device too. The present invention is not limited to any particular input-unrelated device.

Each of the two Lenz routes comprises an input-unrelated device, at least a PDR-equipped device demonstrated by a PDR-equipped device, and at least a NDR-equipped device demonstrated by a NDR-equipped device serially coupled with each other. Any one or both the PDR-equipped and NDR-equipped devices can be the input-unrelated device or the transmission line or an added device. The first Lenz route parallel to the first inductor 101 comprises an input-unrelated device 109, at least a PDR-equipped device demonstrated by a PDR-equipped device 110, and at least a NDR-equipped device demonstrated by a NDR-equipped device 111 serially coupled with each other. The two ends of the second Lenz route respectively electrically connect the drain and source of the power module 105 in which the second Lenz route comprises an input-unrelated device 112, at least a PDR-equipped device demonstrated by a PDR-equipped device 113, and at least a NDR-equipped device demonstrated by a NDR-equipped device 114 serially coupled with each other. The serially coupled PDR-equipped device or devices and NDR-equipped device or devices in a Lenz route has damping effect which can quickly dissipate the Lenz power flowing in the Lenz route. The input-unrelated device 109 is used to let the reversed Lenz current flowing the Lenz route bypass the first inductor 101 and block the normal current from the power source flowing the Lenz route so that the normal current from the power source will still flow thru the first inductor 101. The present invention is not limited to any particular switch, for example, the switch can be a MOSFET device, IGBT device or Thyristor device etc. A switch with Lenz route design can have better protection against Lenz effect in a circuit and can also cancel the parasitic capacitance in the switch such as power module. The Lenz route can be embedded and packaged into the switch.

The Lenz loop of the first inductor 101 shown in FIG. 1 carries the information of the frequency response of the load concealed in the reversed Lenz current or Lenz voltage, and, the loop must includes at least a resistor, an inductor and a capacitor to be frequency-responding. For the first inductor 101, the load can be viewed as the low side from the first inductor 101 in the circuit. The frequency response of the load can be coupled out of the Lenz route by a signal-coupling device. The signal-coupling device 116 can be different type depending on the types of the coupled signals. The signal-coupling device can be a capacitor, an inductor or a resistor. FIG. 2 has shown a capacitor 203 as a signal-coupling device coupled with a Lenz route and FIG. 3 has shown a general Hall device 303 as a signal-coupling device coupled with a Lenz route. The present invention uses the term “signal-coupling device” to include all the possible cases.

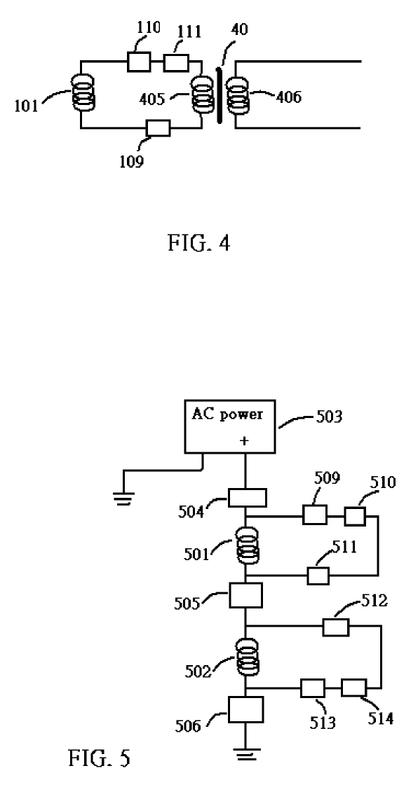

The first Lenz route of the first inductor 101 can further comprise a transformer coil of a transformer for delivering the Lenz power to another loop thru the transformer. FIG. 4 has shown a first transformer coil 405 of a transformer 40 serially coupled in the first Lenz route and the Lenz current flowing thru the first transformer coil 405 can induce a voltage on the second transformer coil 406 of the transformer 40 to deliver the Lenz power to an outside loop thru the transformer 40.

Another embodiment associated with an AC power source is shown in FIG. 5. The Lenz voltage will be generated at the inductor or inductors when AC current flowing thru a loop, and, the Lenz current generated by the Lenz voltage can not flow through an inductor in the loop because the inductor's impedance can become very high. A Lenz route parallel to each inductor is needed. A loop with an AC power source shown in FIG. 5 includes an AC power source 503, a first inductor 501, a second inductor 502, a first block 504, a second block 505 and a third block 506 serially coupled with each other. The blocks 504, 505 and 506 respectively stand for any “possible” component and/or subsystem.

A third Lenz route, which has the same structure as the first and second Lenz routes of the first inductor shown in FIG. 1, parallel to the first inductor 501 comprises an input-unrelated device 509, at least a PDR-equipped device demonstrated by a PDR-equipped device 510 and at least a NDR-equipped device demonstrated by a NDR-equipped device 511. It's the same thing for the second inductor 502 too. Theoretically, each inductor has a Lenz route to handle the reversed Lenz current except the inductance of an inductor can be neglected.

Each Lenz route can further comprises a transformer coil of a transformer which is used to deliver the Lenz power to another outside loop thru the transformer.

From the equations (4), (5) and (9.2), a back flow current exists in any closed loop. The back flow current will interfere with the normal current from the power source resulting in lowering the circuit's performance. If a device, which can be called decoupler in the present invention, can decouple the back flow current and lead the back flow current into a path different from the path from power source then the power of the back flow current can be recycled. The decoupler has at least two requirements: (1) the decoupler is for decoupling the back flow current and it includes at least four ports in which two ports, which can be called as input ports, are for input current and the other two ports, which can be called output ports, are for output current, and the path of the input current is different from the path of the output current, and the decoupled back flow current is guided to the output ports, (2) the decoupler has NDR property for the loop formed by its two output ports. FIG. 7 has shown the symbol of a four-port decoupler in which the input current flows thru the input ports 1 and 2 and the output current flows thru the output ports 3 and 4. The NDR property in the requirement (2) means source which can generate electrical power.

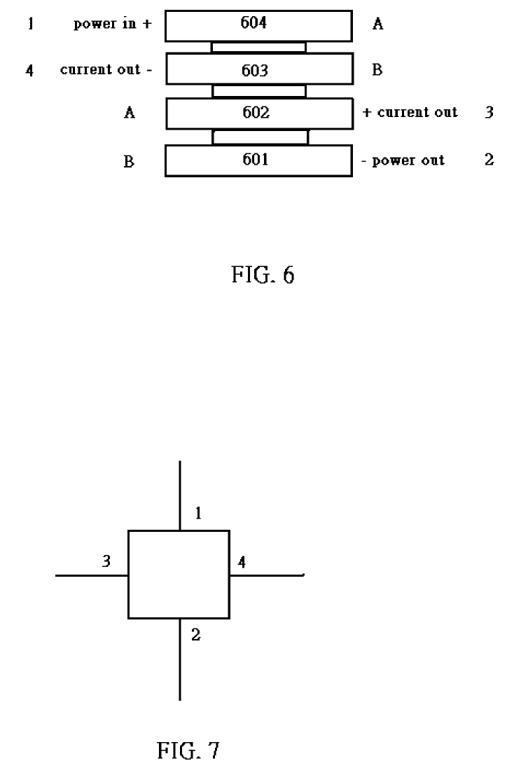

A research of a carbon fiber composite was revealed in a report “Apparent negative electrical resistance in carbon fiber composites” and an experiment of “how to building a four-lamina carbon fiber composite” has been successfully conducted. Both articles are sent in the IDS files with the present invention as references. Upon the observation of the articles, the four-lamina carbon fiber composite has shown NDR property and good linearity. FIG. 6 has shown a simplified structure of the four-lamina carbon fiber composite. The composite has four laminas of which one end of a fourth lamina 604 is for power input which is also marked as 1 and the other end of the fourth lamina 604 marked as A electrically connects one end of a second lamina 602 marked as A. One end of a third lamina 603 marked as B electrically connects one end of a first lamina 601 marked as B and the other end of the first lamina 601 is for power output which is marked as 2. The opposite end, which is also marked as 3, to the end marked as A of the second lamina 602 and the opposite end, which is also marked as 4, to the end marked as B of the third lamina 603 are for the output current. The marks 1, 2, 3, and 4 are respectively referred to the four ports of the decoupler shown in FIG. 7.

Upon the observation of the articles and experiment of the four-lamina carbon fiber composite, firstly, the four-lamina carbon fiber composite is a 4-port device of which two ports are for input and the other two ports are for output. The back flow current can be decoupled and out thru the output ports so that the path of the output current is different from the path of the input current. Secondly, the four-lamina carbon fiber composite has NDR property for the loop formed by its two output ports. Thirdly, there is almost no phase shift seen between the input and output, which means that the four-lamina carbon fiber composite has no significant inductance and capacitance, and the composite has very small resistance which almost can be in the range of neglect. Fourthly, the four-lamina carbon fiber composite has very high frequency response which is good for its coupled high frequency load. Undoubtedly, the four-lamina carbon fiber composite agrees with the two requirements defined for the decoupler and it can be used as a decoupler.

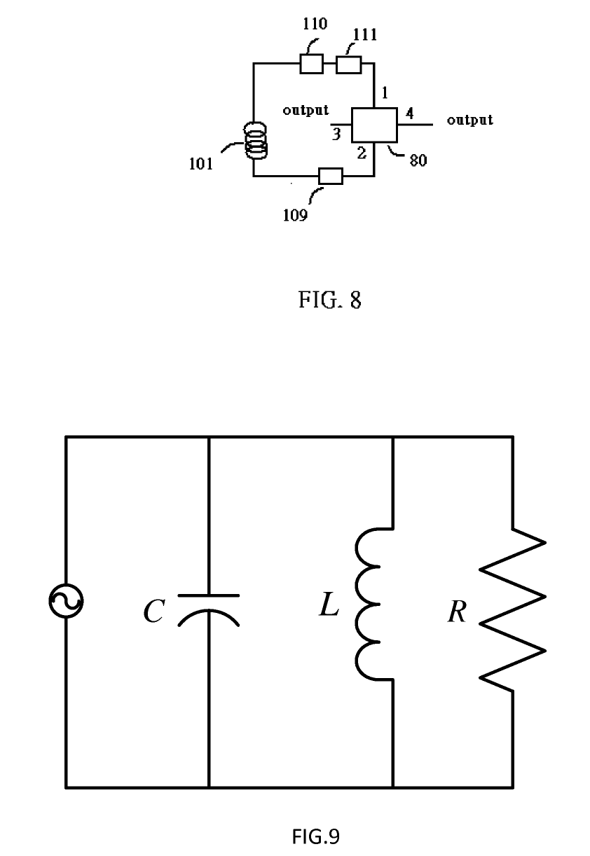

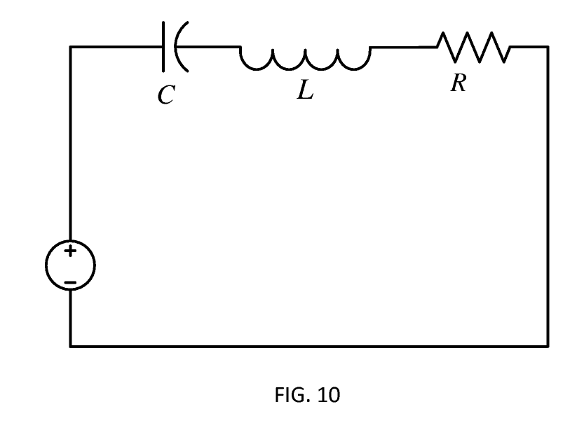

The Lenz current can be coupled out of a Lenz route by placing a decoupler in the Lenz route. The first Lenz route is used as an example. FIG. 8 has shown the first Lenz route which comprises an input-unrelated device 109, a PDR-equipped device 110, a NDR-equipped device 111 and a decoupler 80 serially coupled with each other. The input ports marked as 1 and 2 and the output ports marked as 3 and 4 of the decoupler 80 have been shown in FIG. 8. The Lenz current in the Lenz route can be decoupled thru the output ports of the decoupler 80. Undoubtedly, the four-lamina carbon fiber composite is one embodiment of decoupler 80.

### REFERENCES

[1] Tom M. Apostol. Mathematical Analysis. Addison-Wesley Publishing Company., http://www.aw-bc.com/, 2nd edition, 1975.
[2] V. I. Arnold. Geometrical Methods in the Theory of Ordinary Differential Equations. Springer-Verlag., http://www.springer-ny.com/, 2nd edition, 1988.
[3] E. T. Copson. An introduction to the theory of functions of a complex variable. Oxford University Press., http://www.amazon.com/, 4th edition, 1948.
[4] Theodore Van Duzer and Charles W. Turner. Principles of Superconductive Devices and Circuits. Prentice Hall PTR., http://www.phptr.com, 2nd edition, 1999.
[5] G. N. Watson E. T. Whittaker. A Course of Modern Analysis. Cambridge Mathematical Library., http://www.cambridge.org, 4th edition, 1927.
[6] R. Wong F. Cuker. The Collected Papers of Stephen Smale., volume 3. Singapore University Press., http://www.worldscibooks.com/mathematics, 2000.
[7] John Guckenheimer and Philip Holmes. Nonlinear Oscillations, Dynamical Systems, and Bifurcations of Vector Fields. Springer-Verlag., http://www.springer-ny.com/, 1997.
[8] Morris W. Hirsh and Stephen Smale. Differential Equations, Dynamical Systems and Linear Algebra. Academic Press., http://www.academicpress.com/, 1974.
[9] Thomas J. R. Hughes. Jerrold E. Marsden. Mathematical Foundations of Elasticity. Prentice-Hall, Inc., http://www.doverpublications.com/, 1984.
[10] D. W. Jordan and Peter Smith. Nonlinear Ordinary Differential Equations. Oxford University Press., http://www.oup.co.uk/academic/, 3rd edition, 1999.
[11] Lawrence Perko. Differential Equations and Dynamical Systems. Springer-Verlag, New York, Inc., http://www.springer-ny.com, 3rd edition, 2000.
[12] Steven H. Strogatz. Nonlinear Dynamics and Chaos: With Applications to Physics, Biology, Chemistry and Engineering. Perseus Books Group., http://www.westviewpress.com, 1st edition, 2001.
[13] Matthew Sands. W Richard P. Feynman, Robert B. Leighton. Feynman Lectures On Physics: The Complete And Definitive Issue., volume 3. Addison Wesley Publishing Company., http://www.aw-bc.com, 2nd edition, 1964.
[14] A. David Wunsch. Complex Variables with Applications. Addison-Wesley Publishing Company Inc., http://www.aw-bc.com/, 1983.
[15] Ling Ye and Xiangyang Peng. Selected Topics in Condensed Matter Physics. Fudan University Press., http://www.fudanpress.com, 2003.

What is claimed is:

1. An assembly comprising:
an inductor; and
a Lenz route parallel to the inductor comprising an input-unrelated device, at least a PDR-equipped device and at least a NDR-equipped device serially coupled with each other.

2. The assembly of claim 1, wherein the Lenz route further comprises a transformer coil of a transformer serially coupled with each other.

3. The assembly of claim 1, wherein the Lenz route further comprises a decoupler serially coupled with each other.

4. The assembly of claim 1, wherein the Lenz route further comprises a transmission line for electrically coupling the devices in the Lenz route.

5. The assembly of claim 1, wherein the input-unrelated device is a diode, a variator or a capacitor.

6. The assembly of claim 3, wherein the decoupler is a four-lamina carbon fiber composite.

7. The assembly of claim 1, wherein a loop formed by the first inductor and the Lenz route is a RLC-equipped loop.

8. The assembly of claim 1, wherein the input-unrelated device is the PDR-equipped device.

9. The assembly of claim 1, wherein the input-unrelated device is the NDR-equipped device.

10. The assembly of claim 4, wherein the transmission line is the PDR-equipped device.

11. The assembly of claim 4, wherein the transmission line is the NDR-equipped device.

12. A switch comprising:
a first terminal;
a second terminal;
a third terminal for providing the control of the electrical connection or disconnection of the first terminal and the second terminal; and
a Lenz route with its two ends respectively electrically coupling the first and second terminals comprising an input-unrelated device, at least a PDR-equipped device and at least a NDR-equipped device serially coupled with each other.

13. The switch of claim 12, wherein the Lenz route further comprises a transmission line for electrically coupling the devices in the Lenz route.

14. The switch of claim 12, wherein the input-unrelated device is a diode, a variator or a capacitor.

15. The switch of claim 12, wherein the input-unrelated device is the PDR-equipped device.

16. The switch of claim 12, wherein the input-unrelated device is the NDR-equipped device.

17. The switch of claim 12, wherein the transmission line is the PDR-equipped device.

18. The switch of claim 12, wherein the transmission line is the NDR-equipped device.

19. The assembly of claim 1, wherein the frequency response of the loop formed by the inductor and Lenz route can be coupled out thru a frequency coupling device.

20. The switch of claim 12, wherein the switch is a power module.
